(19) United States
(12) Patent Application Publication
(10) Pub. No.: US 2004/0135047 A1
(43) Pub. Date: Jul. 15, 2004

(54) Tie-back assembly and method

(76) Inventor: Robert E. Hunt, Evansville, IN (US)

Correspondence Address: BAKER & HOSTETLER LLP, Washington Square, Suite 1100, 1050 Connecticut Avenue, N.W., WASHINGTON, DC, 20036, US

(21) Appl. No.: 10/331,638

(22) Filed: Dec. 31, 2002

(51) Int. Cl. F16B 1/00

(52) U.S. Cl. 248/229.14

(57) ABSTRACT

An assembly and method for connecting a anti-rotation arm of an antenna structure to a support structure such as an antenna tower member accommodates angular differences between the anti rotation rod and the tower member, and accommodates attachment to various types of anti rotation rods, and/or various cross sectional types of tower members.

### FIELD OF THE INVENTION

The invention in general pertains to assemblies and methods for providing mechanical connection between two members, such as for example attaching a first member having an elongated round or angled cross section to a second member having an elongated round or angled cross section. More particularly, the invention pertains to connecting, for example, an anti-rotation arm of an antenna to a structural member such as a structural member in an antenna mounting tower.

### BACKGROUND OF THE INVENTION

It is known in the field of antennas to mount various types of antennas and/or antenna components to supporting structures such as for example to antenna towers. Many antennas, particularly for example dish antennas, often need to be aligned in a relatively precise orientation. For example, if the antenna is a directional dish antenna, it is typically desired that the dish antenna be aimed properly for transmitting and receiving the signal to or from where it is receiving or sending signals. This requires mounting the antenna in such a way that it remains rigidly fixed to maintain the proper alignment.

A drawback of the need for maintaining proper orientation of antennas is that antennas are often subjected to a wide range of loads and forces during operation. For example, besides the weight of the antenna which must be supported, antennas in the outdoors are frequently subjected to potentially high wind loads, as well as forces from precipitation and/or ice build up.

One solution to this problem has been to provide a type of antenna mount whose primary purpose is to affix the antenna structure directly onto the supporting structure such as the tower member, and to also provide a supplemental attachment point on the antenna structure, commonly referred to as an anti-rotation arm. The anti-rotation arm is then fixed relative to the tower structure by an attachment device, commonly referred to as a “tic-back”, that secures the anti-rotation arm to the tower structure in such a way as to prevent movement of the antenna relative to the tower.

A benefit of this tie-back arrangement is that the primary mount structure does not have to resist all of the forces in all of the directions that the antenna is subjected to. Further, this permits the mount to be designed to have some pivoting degree of freedom relative to the antenna tower, which facilitates aiming the antenna. When the antenna is properly aimed, the tie-back can be attached to the anti-rotation arm and the tower member to prevent any movement away from the aimed position by the antenna.

A disadvantage of known tie-back and anti-rotation arm arrangements is that they frequently need to be custom-configured for each particular application. That is, an installer or manufacturer often has to provide a specific set of components in order to fit the cross section shape and size of the tower member and the angle of the tower member relative to the anti-rotation arm.

Accordingly, it would be desirable to have an assembly and method for connecting a anti-rotation arm of an antenna structure to a support structure such as an antenna tower member.

Further, it would be desirable if this assembly and method accommodated angular differences between the anti rotation rod and the tower member. It would also be desirable if the assembly and method could accommodate attachment to various types of anti rotation rods, and/or various cross sectional types of tower members.

### SUMMARY OF THE INVENTION

It is therefore a feature and advantage of the present invention to provide an assembly and method for connecting a part such as an anti-rotation arm of an antenna structure to a support structure such as an antenna tower member.

It is another feature and advantage of the present invention to provide an assembly and method that accommodates angular differences between the anti rotation arm and the tower member. It is still another feature and advantage of the invention to provide an assembly and method that accommodates attachment to various types of anti rotation arms, and/or various cross sectional types of tower members.

The above and other features and advantages are achieved through the use of a novel assembly and method as herein disclosed. In accordance with one embodiment of the present invention, an apparatus for connecting a part to a structural member is provided, comprising: a first clamp assembly that clamps to the part; an angle bracket having an L-shaped cross section that is attached to the first clamp assembly; and a second clamp assembly that clamps on to the second structural member, wherein the first clamp assembly and the angle bracket are attached to select between (1) permitting pivoting relative to each other and (2) preventing pivoting relative to each other, and wherein the second clamp assembly and the angle bracket are attached to select between permitting pivoting relative to each other and preventing pivoting relative to each other.

In accordance with another embodiment of the present invention, an apparatus for connecting a part to a structural member is provided, comprising: first means for clamping on to the part; an angle bracket having an L-shaped cross section that is attached to the first clamping means; second means for clamping on to the second structural member; means permitting pivoting of the first clamping means relative to the angle; and means permitting pivoting of the second clamping means relative to the angle bracket.

In accordance with yet another embodiment, a method for connecting a part to a structural member is provided, comprising: clamping a first clamp assembly to the part; pivotally attaching an angle bracket having an L-shaped cross section to the clamp assembly; and pivotally attaching the angle bracket to a second clamp assembly; and clamping the second clamp assembly on to the second structural member, wherein the first clamp assembly and the angle bracket are attached to select between permitting pivoting relative to each other and preventing rotation relative to each other, and wherein the second clamp assembly and the angle bracket are attached to select between permitting pivoting relative to each other and preventing pivoting relative to each other.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side view of a tie back assembly according to a preferred embodiment of the present invention.

FIG. 2 is a end view of the assembly of FIG. 1.

FIG. 3 is an side view of the assembly of FIG. 1, showing various positions and phantom lines.

FIG. 4 is a end view of the assembly of FIG. 1, showing various positions and phantom lines.

FIG. 5 is an side view of an alternative embodiment of the present invention.

FIG. 6 is a top view of a clamp according to a preferred embodiment of the present invention.

FIG. 7 is a side view of the clamp shown in FIG. 6.

FIG. 8 is an end view of the clamp shown in FIG. 6.

FIG. 9 is a side view showing a clamp attaching to a tower member.

FIG. 10 is a side view showing a clamp attaching to a tower member.

FIG. 11 is a side view showing a clamp attaching to a tower member.

FIG. 12 is a side view showing a clamp attaching to a tower member.

FIG. 13 is a side view showing a clamp attaching to a tower member.

### DETAILED DESCRIPTION OF PREFERRED EMBODIMENTS OF THE INVENTION

The invention will now be described with reference to the drawings, in which like reference numerals identify like parts throughout.

In general, certain embodiments of the invention allow for the attachment of a part, such as a round rod serving an anti rotation arm, to a structural member, such as a round or angled tower member. The part and the structural member may be at any angle, such as for example horizontal, vertical, or tilted, and may also be parallel or at angles to each other. In the embodiment described below, the anti rotation arm is shown as a generally horizontal tubular member, and the tower member is a generally horizontal right angle bar.

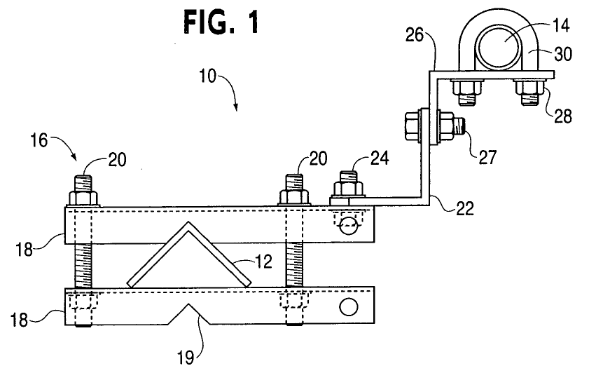

FIG. 1 is a side view of a preferred embodiment of the tie-back assembly 10 attached to a tower member 12 in such a way that it can also attach to the anti rotation arm 14. The tie back assembly 10 has a tower member clamp assembly 16 which clamps onto the tower member 12.

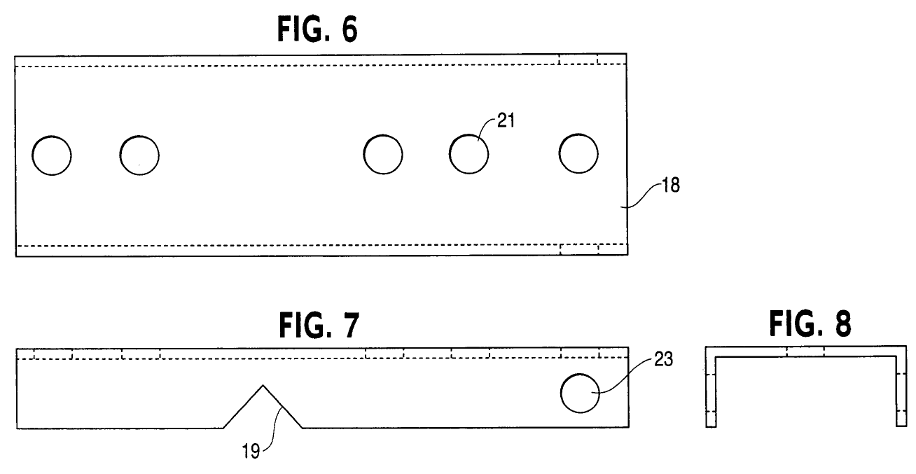

The tower member clamp assembly 16 includes two member clamps 18 and two threaded rods 20 which permit the member clamps 18 to reside on opposing sides of the tower member 12 and clamp onto the tower member 12 as the bolts of the threaded rods 20 are tightened. The tower member clamp assembly 16 also comprises two member clamps 18, each substantially identical to each other, and shown in more detail in FIGS. 6-8.

Each member clamp 18, as shown in FIGS. 6-8 has a generally U-shaped channel with a notch 19 on the rails of the channel, and holes 21 for receiving the threaded rods 20. The holes 21 can be provided at a variety of locations in order to provide a variety of possible widths between the threaded rods 20, in order to accommodate various sizes of tower members 12. Each member clamp 18 also includes a hole for receiving a bolt 24 for connecting the member clamp assembly to an adapter angle 22.

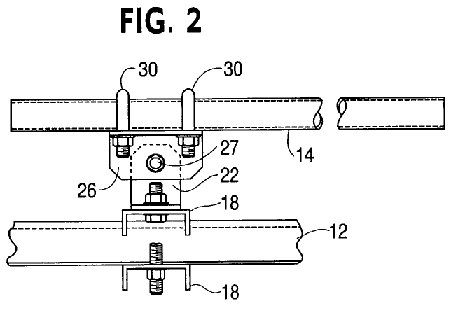

Returning to FIGS. 1 and 2, the member clamp assembly 16 is attached by the bolt 24 to an adapter angle piece 22 as shown. A bolt 27 connects the adapter angle piece 22 to a clamp bracket 26 as shown. A pair of U-bolts 30 partially surround the anti rotation arm 14 and together with the clamp bracket 26 secures onto the anti rotation arm 14 by tightening of the bolts 28.

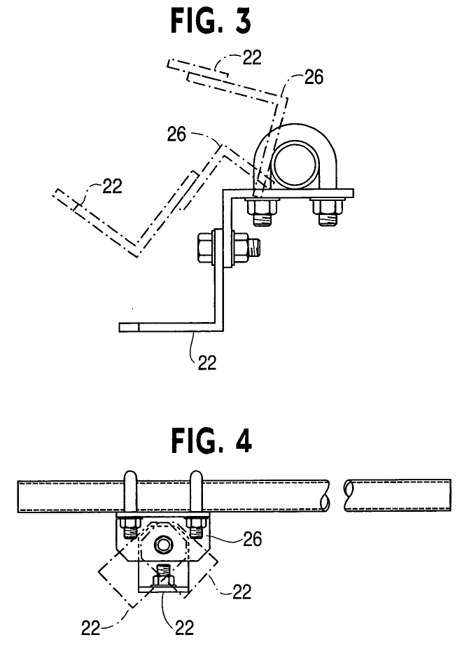

It will be appreciated that this structure 10 is capable of connecting a anti rotation arm 14 to a tower member 12, with sufficient degrees of freedom to permit securing these parts together while accommodating a difference in angle between them. The assembly 10 provides three rotational degrees of freedom described below. The first degree of freedom is illustrated in FIG. 3, wherein the clamp 26 and U-bolts 30 are capable when loosened of a rotating around the rotation arm 14, providing a first degree of freedom. When the device 10 has been installed, tightening of the bolts 28 on U-bolt 30 secures the members against further movement in that direction.

The second rotational degree of freedom is illustrated in FIG. 4, wherein the adapter angle 22 can rotate about the bolt 27 so that it can rotate relative to the clamp 26 as shown. This provides a second rotational degree of freedom for installation, which can be secured by tightening the bolt 27 once installation is complete.

A third degree of freedom is provided by the bolt 24, which permits the member clamp 16 to rotate relative to the adapter angle 22. This degree of rotational freedom is secured by tightening the bolt 24 upon installation.

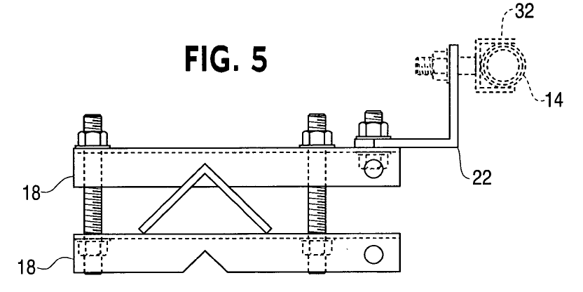

FIG. 5 illustrates an alternative embodiment of the invention, wherein the clamp 26 and U-bolt 30 are replaced by a conventional bolt clamp component 32. Some conventional anti rotation arms 14 are supplied with a conventional bolt clamp 32 that clamps onto the anti rotation arm 14 and provides a bolt mounting point. This bolt clamp 32 can be attached directly onto the adapter angle at the location where the bolt 27 resides in the embodiment of FIG. 1.

It will be appreciated that a benefit of the device 10 is that it provides easy interchangeability for antennas supplied with a bolt clamp (as illustrated in FIG. 5), and those that require some additional clamping arrangement (such as the universal clamp 26 and U-bolt provided by the embodiment of the invention in FIG. 1).

Referring now to FIGS. 6-8, an embodiment of a member clamp 18 is illustrated. Two of the member clamps 18 can be used together with threaded rods 20 to former the member clamp assembly 16. The member clamp assembly 16 can attach to a wide variety of sizes and shapes of tower members 12 and provides a significant benefit of the arrangement of the member clamp assembly 16 in the preferred embodiments, since it is readily adaptable to various tower member types that exist. This provides for a convenient adaptability of the preferred embodiment of the invention onto these various types of tower members.

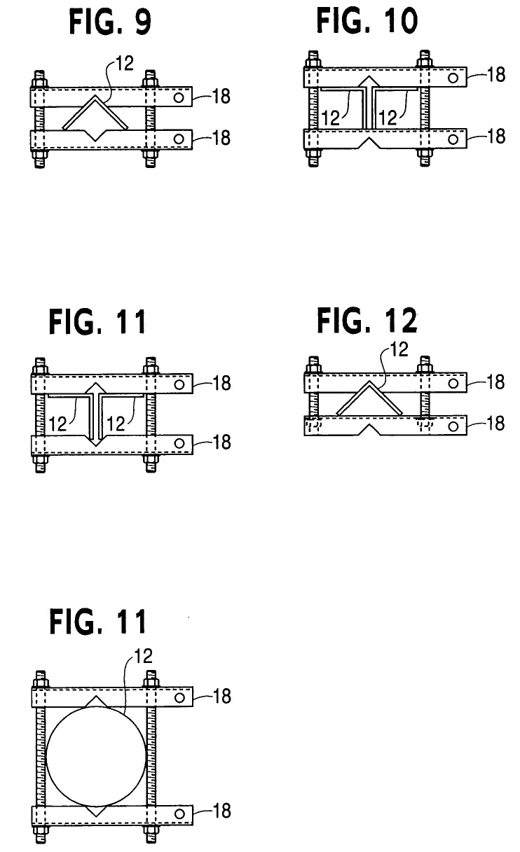

FIGS. 9-13 show the member clamp assembly 16 being able to be configured in various arrangements to accommodate various tower members 12. For example, in FIG. 9, the tower member 12 has an L-shaped cross section such as shown in FIG. 1. The clamps 18 can be faced with the U-channels facing towards each other as shown. FIG. 10 shows the tower member 12 being a pair of L-shaped members which are contained between the two member clamps 18 and with their channels facing in the same direction as each other. FIG. 11 shows a different configuration for connecting to the tower member structure shown in FIG. 10. Here, the ends of the tower members 12 rest in the channel in a notch 19 of one of the clamp members. FIG. 12 shows another arrangement for attaching to the tower member 12 shown in FIG. 9, where the vertex of the tower member fits within the notches 19. FIG. 13 shows the clamps 18 used to clamp onto a tower member 12 having a circular cross section, with the circle resting to some extent in the notches 19, the U-channels facing towards each other, and the bolts 20 providing an additional lateral connection restraining force.

It will be appreciated that the embodiments described above allow for the attachment of a round steel arm (e.g., an anti rotation arm) to a member (e.g., a tower member) located at the angle thereto. The tower member is often made of steel, and can be round or angled with various sizes. The invention provides the benefit of being able to accommodate a wide range of anti rotation arms and similar braces and mount them to structural members such as tower members which may have a size or relative location or angle which can vary depending on the application. It will be appreciated that embodiments of the invention can provide in this way a somewhat universal attachment bracket that can attach two components at a desired angle.

Further, it will be appreciated that embodiments according to the invention can be particularly convenient to assemble, requiring only the tightening of bolts, and be also conveniently be manufactured from relatively simple components.

Moreover, the process of adapting embodiments of the invention to a particular size or type of anti rotation arm and/or size or type of tower member can be conveniently accomplished by simply changing a few components, such as for example the size of the universal clamp 26 and U-bolt 30, by changing for example the placement of the bolt 20 in the member clamps 18, and/or by changing the orientation of the member clamps 18 relative to each other (e.g. by facing them towards or away from each other).

Embodiments of invention have been described herein in the context of attaching a round tubular rotation arm to an angle iron tower member. However, the invention is also useful for attaching to items other than anti rotation rods, such as for example other antenna componentry. Further, although the preferred embodiments are discussed as being attached to a tower member, the invention may be useful to attach to any type of supporting structure, such as for example a truss, scaffold, building framework, or other type of frame member.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for connecting a part to a structural member, comprising:
a first clamp assembly that clamps to the part;
an angle bracket having an L-shaped cross section that is attached to the first clamp assembly; and
a second clamp assembly that clamps on to the second structural member, wherein the first clamp assembly and the angle bracket are attached to select between (1) permitting pivoting relative to each other and (2) preventing pivoting relative to each other, and wherein the second clamp assembly and the angle bracket are attached to select between permitting pivoting relative to each other and preventing pivoting relative to each other.

2. An apparatus according to claim 1, wherein the second clamp comprises a pair of U-shaped channel members connected to each other by threaded rods to surround the structural member.

3. An apparatus according to claim 1, wherein the first clamp assembly comprises a clamp bracket having an L-shaped cross section and a U-bolt partially surrounding the part so that the U-bolt and the L-shaped bracket clamp onto and surround the part.

4. An apparatus according to claim 1, wherein the structural member has an L-shaped cross section.

5. An apparatus according to claim 1, wherein the part is a tube having a round cross section.

6. An apparatus according to claim 1, wherein the structural member is a tower structure.

7. An apparatus according to claim 1, wherein the part is an anti rotation rod of an antenna.

8. An apparatus for connecting a part to a structural member, comprising:
first means for clamping on to the part;
an angle bracket having an L-shaped cross section that is attached to the first clamping means;
second means for clamping on to the second structural member;
first means permitting pivoting of the first clamping means relative to the angle; and
first means permitting pivoting of the second clamping means relative to the angle bracket.

9. An apparatus according to claim 8, wherein the second clamping means comprises a pair of U-shaped channel members connected to each other by threaded rods to surround the structural member.

10. An apparatus according to claim 8, wherein the first clamping means comprises a clamp bracket having an L-shaped cross section and a U-bolt partially surrounding the part so that the U-bolt and the L-shaped bracket clamp onto and surround the part.

11. The apparatus according to claim 8, wherein the structural member has an L-shaped cross section.

12. Apparatus according to claim 8, wherein the part is a tube having a round cross section.

13. Apparatus according to claim 8, wherein the structural member is a tower structure.

14. The apparatus according to claim 8, wherein the part is an anti rotation rod of any antenna.

15. A method for connecting a part to a structural member, comprising:
clamping a first clamp assembly to the part;
pivotally attaching an angle bracket having an L-shaped cross section to the clamp assembly;
pivotally attaching the angle bracket to a second clamp assembly; and
clamping the second clamp assembly on to the second structural member, wherein the first clamp assembly and the angle bracket are attached to select between permitting pivoting relative to each other and preventing rotation relative to each other, and wherein the second clamp assembly and the angle bracket are attached to select between permitting pivoting relative to each other and preventing pivoting relative to each other.

16. The method according to claim 15, wherein the second clamping assembly comprises a pair of U-shaped channel members connected to each other by threaded rods to surround the structural member.

17. The method according to claim 15, wherein the first clamping assembly comprises a clamp bracket having an L-shaped cross section and a U-bolt partially surrounding the part so that the U-bolt and the L-shaped bracket clamp onto and surround the part.

18. The method according to claim 15, wherein the structural member has an L-shaped cross section.

19. The method according to claim 15, wherein the part is a tube having a round cross section.

20. The method according to claim 15, wherein the structural member is a tower structure.

21. The method according to claim 15, wherein the part is an anti rotation rod of and antenna.
